(19) United States
(12) Patent Application Publication
(10) Pub. No.: US 2026/0205725 A1
(43) Pub. Date: Jul. 16, 2026

(54) HEAD-MOUNTED DISPLAY AND METHOD OF SOUND RECORDING

(71) Applicant: HTC Corporation, Taoyuan City (TW)

(72) Inventors: Li-Yen Lin, Taoyuan City (TW); Yan-Min Kuo, Taoyuan City (TW)

(73) Assignee: HTC Corporation, Taoyuan City (TW)

(21) Appl. No.: 19/023,346

(22) Filed: Jan. 16, 2025

(51) Int. Cl. H04R 1/02; H04R 1/08

(52) U.S. Cl. CPC H04R 1/025; H04R 1/08

(57) ABSTRACT

A head-mounted display and a method of sound recording are provided. The method includes: disposing a microphone array on a head-mounted display and aligning a first microphone of the microphone array and a second microphone of the microphone array along a first direction, wherein the head-mounted display captures an image through a camera; controlling the first microphone and the second microphone to form a first acoustic beam; and capturing a first sound signal corresponding to the image according to the first acoustic beam, and outputting a processed sound signal associated with the first sound signal.

### BACKGROUND

### Technical Field

The disclosure is related to head-mounted display (HMD) technology, and particularly related to an HMD and a method of sounding recording.

### Description of Related Art

Typically, recording stereoscopic video requires a specialized video camera combined with an external ambisonic microphone setup. These ambisonic microphones, consisting of multiple directional microphones oriented in different directions, record multiple audio tracks. These tracks are then processed to produce B-format ambisonic (W, X, Y, Z), where W represents overall amplitude and X, Y, and Z correspond to the three spatial axes. The recorded audio and recorded video are then aligned to produce synchronized stereoscopic media with spatial audio.

However, ambisonic microphones are expensive and require additional recording equipment. When used with HMDs, such as augmented reality (AR) HMDs, users must set up separate devices, which cannot seamlessly record audio based on a first-person perspective.

### SUMMARY

The disclosure is directed to an HMD and a method of sound recording based on a microphone array.

The present invention is directed to a head-mounted display, including a camera, a microphone array, and a processor. The camera captures an image. The microphone array includes a first microphone and a second microphone, wherein the first microphone and the second microphone are aligned along a first direction. The processor is coupled to the camera and the microphone array, wherein the processor controls the first microphone and the second microphone to form a first acoustic beam, wherein the processor captures a first sound signal corresponding to the image according to the first acoustic beam, and the processor outputs a processed sound signal associated with the first sound signal.

In one embodiment of the present invention, the microphone array further includes a third microphone, wherein the first microphone and the third microphone are aligned along a second direction, wherein the processor controls the first microphone and the third microphone to form a second acoustic beam, wherein the processor captures a second sound signal corresponding to the image according to the second acoustic beam.

In one embodiment of the present invention, the microphone array further includes a fourth microphone, wherein the first microphone and the fourth microphone are aligned along a third direction, wherein the processor controls the first microphone and the fourth microphone to form a third acoustic beam, wherein the processor captures a third sound signal corresponding to the image according to the third acoustic beam.

In one embodiment of the present invention, the processor performs data fusion on the first sound signal, the second sound signal, and the third sound signal to generate the processed sound signal corresponding to the image.

In one embodiment of the present invention, the processor converts the processed sound signal from a first coordinate system to a second coordinate system of the camera according to a sound transfer function.

In one embodiment of the present invention, the second direction is perpendicular to the first direction.

In one embodiment of the present invention, the first direction is parallel to a first axis of a coordinate system of the camera.

In one embodiment of the present invention, the first microphone includes an omnidirectional microphone.

The present invention is directed to a method of sound recording, including: disposing a microphone array on a head-mounted display and aligning a first microphone of the microphone array and a second microphone of the microphone array along a first direction, wherein the head-mounted display captures an image through a camera; controlling the first microphone and the second microphone to form a first acoustic beam; and capturing a first sound signal corresponding to the image according to the first acoustic beam, and outputting a processed sound signal associated with the first sound signal.

In one embodiment of the present invention, the method further including: aligning the first microphone and a third microphone of the microphone array along a second direction; controlling the first microphone and the third microphone to form a second acoustic beam; and capturing a second sound signal corresponding to the image according to the second acoustic beam.

In one embodiment of the present invention, the method further including: aligning the first microphone and a fourth microphone of the microphone array along a third direction; controlling the first microphone and the fourth microphone to form a third acoustic beam; and capturing a third sound signal corresponding to the image according to the third acoustic beam.

In one embodiment of the present invention, the method further including: performing data fusion on the first sound signal, the second sound signal, and the third sound signal to generate the processed sound signal corresponding to the image.

In one embodiment of the present invention, the method further including: converting the processed sound signal from a first coordinate system to a second coordinate system of the camera according to a sound transfer function.

In one embodiment of the present invention, the second direction is perpendicular to the first direction.

In one embodiment of the present invention, the first direction is parallel to a first axis of a coordinate system of the camera.

In one embodiment of the present invention, the first microphone includes an omnidirectional microphone.

Based on the above description, the HMD of the present invention may obtain ambisonic audio without using an external ambisonic microphone.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of an HMD according to one embodiment of the present invention.

FIG. 2 illustrates a schematic diagram of the microphone array according to one embodiment of the present invention.

FIG. 3 illustrates a front view and a side view of a user wearing the HMD according to one embodiment of the present invention.

FIG. 4 illustrates a schematic diagram of acoustic beam according to one embodiment of the present invention.

FIG. 5 illustrates a schematic diagram of coordinate systems according to one embodiment of the present invention.

FIG. 6 illustrates a flowchart of a method of sounding recording according to one embodiment of the present invention.

### DESCRIPTION OF THE EMBODIMENTS

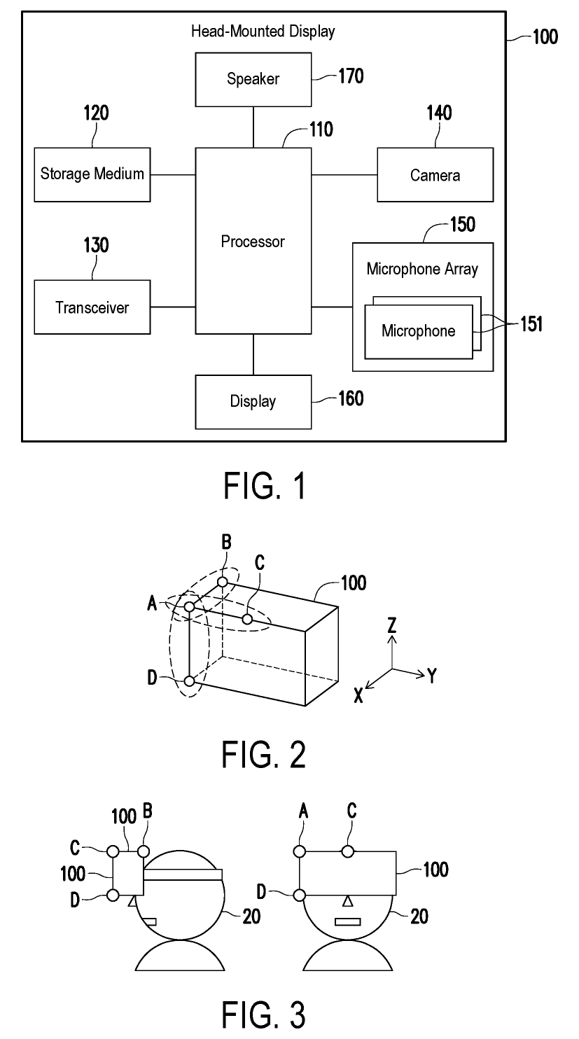

FIG. 1 illustrates a schematic diagram of an HMD 100 according to one embodiment of the present invention. The HMD 100 may be used for providing a XR environment (or XR scene) such as a virtual reality (VR) environment, an AR environment, or a mixed reality (MR) environment for the user. The HMD 100 may include a processor 110, a storage medium 120, a transceiver 130, a camera 140, a microphone array 150, a display 160, and a speaker 170.

The processor 110 may be, for example, a central processing unit (CPU), or other programmable general purpose or special purpose micro control unit (MCU), a microprocessor, a digital signal processor (DSP), a programmable controller, an application specific integrated circuit (ASIC), a graphics unit (GPU), an arithmetic logic unit (ALU), a complex programmable logic device (CPLD), a field programmable gate array (FPGA), or other similar device or a combination of the above devices. The processor 110 may be coupled to the storage medium 120, the transceiver 130, the camera 140, the microphone array 150, the display 160, and the speaker 170.

The storage medium 120 may be, for example, any type of fixed or removable random access memory (RAM), a read-only memory (ROM), a flash memory, a hard disk drive (HDD), a solid state drive (SSD) or similar element, or a combination thereof. The storage medium 120 may be a non-transitory computer readable storage medium configured to record a plurality of executable computer programs, modules, or applications to be loaded by the processor 110 to perform the functions of the HMD 100.

The transceiver 130 may be configured to transmit or receive wired/wireless signals. The transceiver 130 may also perform operations such as low noise amplifying, impedance matching, frequency mixing, up or down frequency conversion, filtering amplifying, and so forth. The processor 110 may communicate with other external devices via the transceiver 130.

The camera 140 may be a photographic device for capturing images. The camera 140 may include a complementary metal oxide semiconductor (CMOS) sensor or a charge-coupled device (CCD) sensor. The processor 110 may capture images by the camera 140.

The microphone array 150 may include a plurality of microphones 151. The microphone 151 may be an omnidirectional microphone. The microphone 151 may include but not limited to an electret condenser microphone (EMC) or a micro-electro-mechanical system (MEMS) microphone.

The display 160 may be used for displaying video data or image data such as an XR scene of the XR environment for the user wearing the HMD 100. The display 160 may include a liquid-crystal display (LCD) or an organic light-emitting diode (OLED) display. In one embodiment, the display 160 may provide an image beam to the eye of the user to form the image on the retinal of the user such that the user may see an XR scene created by the HMD 100.

The speaker 170 may include but not limited to a dynamic speaker, an electrostatic speaker, a planar magnetic speaker, or a piezoelectric speaker.

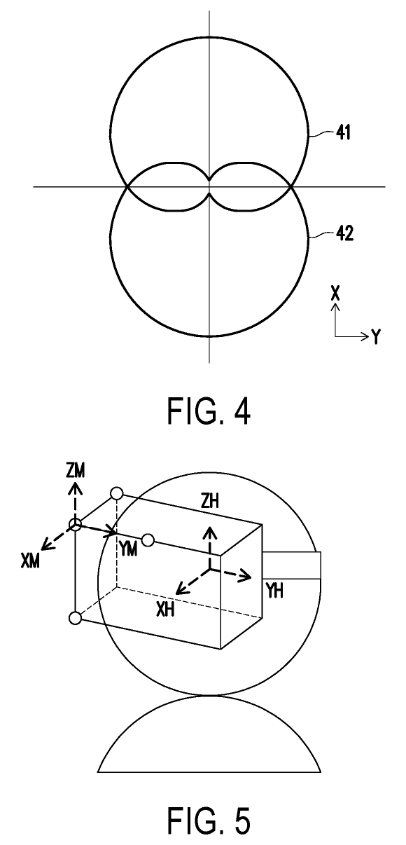

FIG. 2 illustrates a schematic diagram of the microphone array 150 according to one embodiment of the present invention. FIG. 3 illustrates a front view and a side view of a user 20 wearing the HMD 100 according to one embodiment of the present invention. It is assumed that the plurality of microphones 151 may include microphones A, B, C, and D. The microphone A and the microphone B may be aligned along a direction, for example, parallel to the X-axis of a coordinate system (e.g., Cartesian coordinate system) of the camera 140. The microphones A and B may form one or more acoustic beams for capturing sound signals, wherein the one or more acoustic beams may include an acoustic beam 41 directed toward the positive X-direction and an acoustic beam 42 directed toward the negative X-direction, as shown in FIG. 4.

Similarly, the microphones A and C may be aligned along a direction, for example, parallel to the Y-axis of the coordinate system of the camera 140. The microphones A and C may form one or more acoustic beams for capturing sound signals, wherein the one or more acoustic beams may include an acoustic beam directed toward the positive Y-direction and an acoustic beam directed toward the negative Y-direction. The microphones A and D may be aligned along a direction, for example, parallel to the Z-axis of the coordinate system of the camera 140. The microphones A and D may form one or more acoustic beams for capturing sound signals, wherein the one or more acoustic beams may include an acoustic beam directed toward the positive Z-direction and an acoustic beam directed toward the negative Z-direction.

While the camera 140 records images, the processor 110 may capture first sound signals using the acoustic beam formed by the microphones A and B, capture second sound signals using the acoustic beam formed by the microphones A and C, and capture third sound signals using the acoustic beam formed by the microphones A and D. Since the images, the first sound signals, the second sound signals, and the third sound signals are captured simultaneously, no additional signal processing is required for aligning the image and the sound signals. In one embodiment, the microphone array 150 may be disposed on the HMD 100 such that an acoustic beam formed by the microphone array 150 may be aligned with the optical axis of the camera 140. Accordingly, the microphone array 150 may record sound signals from a first-person perspective of the user 20.

To obtain ambisonic audio (i.e., a three-dimensional audio), the processor 110 may perform data fusion on the first sound signals, the second sound signals, and the third sound signals to generate processed sound signals associated with the recorded images. The processor 110 may output the processed sound signals in sync with the recorded images via the display 160 and the speaker 170.

FIG. 5 illustrates a schematic diagram of coordinate systems according to one embodiment of the present invention, wherein O1 represents the origin of the original coordinate system of the processed sound signals (or microphone array 150), XM, YM, and ZM represent the X-axis, Y-axis, and Z-axis of the original coordinate system respectively, O2 represents the origin of the converted coordinate system of the processed sound signals, and XH, YH and ZH represent the X-axis, Y-axis, and Z-axis of the converted coordinate system respectively. In one embodiment, if there is an offset between the coordinate system of the microphone array 150 and the coordinate system of the camera 140 (or the head center of the user 20), the processor 110 may convert the processed sound signals from the coordinate system of the microphone array 150 to the coordinate system of the camera 140 or converts the origin of the processed sound signals to the head center of the user 20 based on a sound transfer function, wherein the sound transfer function may be prestored in the storage medium 120. The sound transfer function may translate or rotate the coordinate system of microphone array 150.

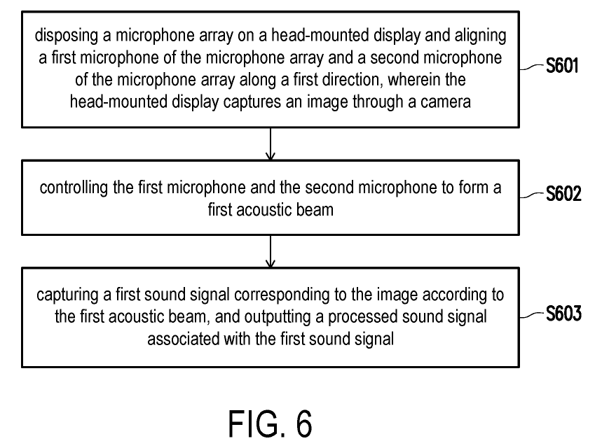

FIG. 6 illustrates a flowchart of a method of sounding recording according to one embodiment of the present invention, wherein the method may be implemented by the HMD 100 as shown in FIG. 1. In step S601, disposing a microphone array on a head-mounted display and aligning a first microphone of the microphone array and a second microphone of the microphone array along a first direction, wherein the head-mounted display captures an image through a camera. In step S602, controlling the first microphone and the second microphone to form a first acoustic beam. In step S603, capturing a first sound signal corresponding to the image according to the first acoustic beam, and outputting a processed sound signal associated with the first sound signal.

In summary, the HMD of the present invention may be configured with a plurality of microphones to form several acoustic beams. The HMD may perform data fusion on the sound signals captured by the acoustic beams to generate ambisonic audio without using an external ambisonic microphone. Additionally, the HMD may capture the image and capture the sound signals simultaneously, such that no additional signal processing is required for aligning the image and the sound signals.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A head-mounted display, comprising:
a camera, capturing an image;
a microphone array, comprising a first microphone and a second microphone, wherein the first microphone and the second microphone are aligned along a first direction; and
a processor, coupled to the camera and the microphone array, wherein
the processor controls the first microphone and the second microphone to form a first acoustic beam, wherein
the processor captures a first sound signal corresponding to the image according to the first acoustic beam, and the processor outputs a processed sound signal associated with the first sound signal.

2. The head-mounted display according to claim 1, wherein the microphone array further comprises:
a third microphone, wherein the first microphone and the third microphone are aligned along a second direction, wherein
the processor controls the first microphone and the third microphone to form a second acoustic beam, wherein
the processor captures a second sound signal corresponding to the image according to the second acoustic beam.

3. The head-mounted display according to claim 2, wherein the microphone array further comprises:
a fourth microphone, wherein the first microphone and the fourth microphone are aligned along a third direction, wherein
the processor controls the first microphone and the fourth microphone to form a third acoustic beam, wherein
the processor captures a third sound signal corresponding to the image according to the third acoustic beam.

4. The head-mounted display according to claim 3, wherein
the processor performs data fusion on the first sound signal, the second sound signal, and the third sound signal to generate the processed sound signal corresponding to the image.

5. The head-mounted display according to claim 4, wherein
the processor converts the processed sound signal from a first coordinate system to a second coordinate system of the camera according to a sound transfer function.

6. The head-mounted display according to claim 2, wherein the second direction is perpendicular to the first direction.

7. The head-mounted display according to claim 1, wherein the first direction is parallel to a first axis of a coordinate system of the camera.

8. The head-mounted display according to claim 1, wherein the first microphone comprises an omnidirectional microphone.

9. A method of sound recording, comprising:
disposing a microphone array on a head-mounted display and aligning a first microphone of the microphone array and a second microphone of the microphone array along a first direction, wherein the head-mounted display captures an image through a camera;
controlling the first microphone and the second microphone to form a first acoustic beam; and
capturing a first sound signal corresponding to the image according to the first acoustic beam, and outputting a processed sound signal associated with the first sound signal.

10. The method according to claim 9, further comprising:
aligning the first microphone and a third microphone of the microphone array along a second direction;
controlling the first microphone and the third microphone to form a second acoustic beam; and
capturing a second sound signal corresponding to the image according to the second acoustic beam.

11. The method according to claim 10, further comprising:
aligning the first microphone and a fourth microphone of the microphone array along a third direction;
controlling the first microphone and the fourth microphone to form a third acoustic beam; and
capturing a third sound signal corresponding to the image according to the third acoustic beam.

12. The method according to claim 11, further comprising:
performing data fusion on the first sound signal, the second sound signal, and the third sound signal to generate the processed sound signal corresponding to the image.

13. The method according to claim 12, further comprising:
converting the processed sound signal from a first coordinate system to a second coordinate system of the camera according to a sound transfer function.

14. The method according to claim 10, wherein the second direction is perpendicular to the first direction.

15. The method according to claim 9, wherein the first direction is parallel to a first axis of a coordinate system of the camera.

16. The method according to claim 9, wherein the first microphone comprises an omnidirectional microphone.
